(19) United States
(12) Patent Application Publication
(10) Pub. No.: US 2005/0039569 A1
(43) Pub. Date: Feb. 24, 2005

(54) Flywheel having an offset center of mass with respect to the axis of rotation

(76) Inventors: Alexandr Minasovich Chentemirov, Moscow (RU); Svetlana Nikolaevna Papuk, Moskovskaya (RU)

Correspondence Address: Richard J Streit;Ladas & Parry, 224 South Michigan Avenue, Suite 1200, Chicago, IL, 60604, US

(21) Appl. No.: 10/499,138

(22) PCT Filed: Dec. 17, 2002
(86) PCT No.: PCT/RU02/00534

(30) Foreign Application Priority Data
Dec. 18, 2001 (RU) 2001134046

(51) Int. Cl. G05G 1/00

(52) U.S. Cl. 74/572

(57) ABSTRACT

The invention relates to mechanical and electric machine engineering. A flywheel (1) with the center of mass offset from the rotation axis (5) is used on shafts of reciprocating and electric motors to amplify power. The flywheel has a shape formed by rotation, around the rotation axis, of a geometric figure symmetric about the rotation axis and the axis perpendicular to the rotation axis, and split into two parts (2, 3), e.g. of equal volume, by a plane passing at an angle greater that forty five degrees and smaller than ninety degrees to the rotation axis, the two parts being rotated relative to each other around the rotation axis at an angle no greater than ninety degrees. The flywheel, being secured on a shaft and driven into rotation, does not generate detrimental mechanical lateral vibrations and substantially reduces longitudinal mechanical vibrations as compared to a conventional flywheel.

### FIELD OF THE INVENTION

The present invention relates to mechanical and electric machine engineering.

### BACKGROUND OF THE INVENTION

A flywheel with the center of mass offset from the rotation axis is described e.g. in RU Application No.99103739. The flywheel has a shape formed by rotation of a geometric figure symmetric about the rotation axis and split into two parts, e.g. of equal volume, by a plane passing at an angle smaller than ninety degrees and greater than zero degrees to the rotation axis, wherein the mass of one part is many times greater than that of the other part, e.g. a hollow one. Such a flywheel, being secured on a shaft and driven into rotation, does not generally generate lateral mechanical vibrations. The flywheel however suffers detrimental longitudinal mechanical vibrations.

### SUMMARY OF THE INVENTION

The object of the present invention is to provide a flywheel with the center of mass offset from the axis of rotation, which flywheel being secured on a shaft and driven into rotation, not only does not generate detrimental lateral mechanical vibrations, but also substantially reduces longitudinal mechanical vibrations as compared to a conventional flywheel.

The above result is attained by a flywheel with the center of mass offset from the axis of rotation in accordance with the present invention, the flywheel having a shape formed by rotation, around the rotation axis, of a geometric figure symmetric about the rotation axis and the axis perpendicular to the rotation axis, and split into two parts, e.g. of equal volume, by a plane passing at an angle greater that forty five degrees and smaller than ninety degrees to the rotation axis. The above two parts are rotated relative to each other around the rotation axis at an angle no greater than ninety degrees.

The invention essentially reduces the longitudinally oscillating mass of the flywheel, this enabling the longitudinal vibrations of the rotated flywheel to be substantially reduced as compared to a conventional flywheel.

### BRIEF DESCRIPTION OF THE DRAWING

The invention will become apparent from the following description of a preferred embodiment with reference to the accompanying drawing which shows a general schematic view of a flywheel with the center of mass offset from the rotation axis.

### DESCRIPTION OF THE PREFERRED EMBODIMENT

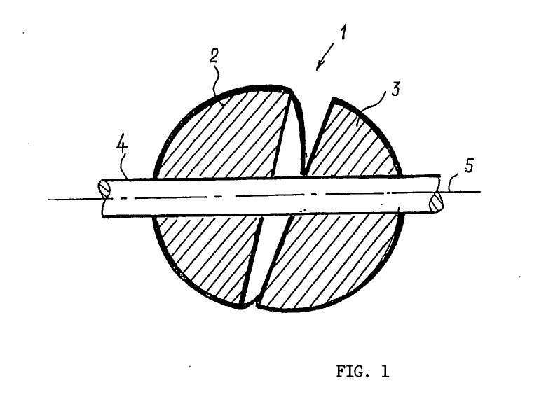

A preferred embodiment of a flywheel 1 (FIG. 1) has a shape formed by splitting a sphere into two parts 2 and 3 which are rotated relative to each other at an angle no greater than 90° (degrees of arc). The flywheel is mounted on a shaft 4 whose axis coincides with the rotation axis 5.

It has been experimentally established that such a flywheel with the center of mass offset from the rotation axis 5 enables the object of the invention to be attained.

### Industrial Applicability

A flywheel with the center of mass offset from the rotation axis can be used on shafts of reciprocating motors and electric motors to amplify power.

1. A flywheel (1) with the center of mass offset from the rotation axis (5), characterized in that the flywheel (1) has a shape formed by rotation, around the rotation axis (5), of a geometric figure symmetric about the rotation axis (5) and the axis perpendicular to the rotation axis, and split into two, e.g. equal, parts (2, 3) by a plane passing at an angle greater that forty five degrees and smaller than ninety degrees to the rotation axis, the two parts being rotated relative to each other around the rotation axis at an greater than zero and smaller than ninety degrees.
